(19) United States
(12) Patent Application Publication
(10) Pub. No.: US 2006/0247970 A1
(43) Pub. Date: Nov. 2, 2006

(54) Cost free economics patronage incentive future benefits system providing cost free goods and services and method and apparatus thereof

(76) Inventor: Michael Sattelmaier, Richmond, VA (US)

Correspondence Address: Michael Sattelmaier, 7229 Monument Ave, Richmond, VA, 23236, US

(21) Appl. No.: 11/413,016

(22) Filed: Apr. 28, 2006

Related U.S. Application Data
(60) Provisional application No. 60/675,894, filed on Apr. 29, 2005.

(51) Int. Cl. G06Q 30/00

(52) U.S. Cl. 705/14

(57) ABSTRACT

A cost free economics future patronage incentive benefits system (10) to provide economic transactions or other transactions (16) that from a smaller amount return as a benefit (25) the entire amount of the transaction or greater (42) to any entity or individual or purchaser or seller and or other party (13), incorporating cost free goods and services and providing the funding (36) of the future benefit total consumer cost free expenditure utilizing an extendable time component (26) to adjust the future payout date through the needed funding period and a system and means to include or not include a commission (42) to purchaser, seller or other party.

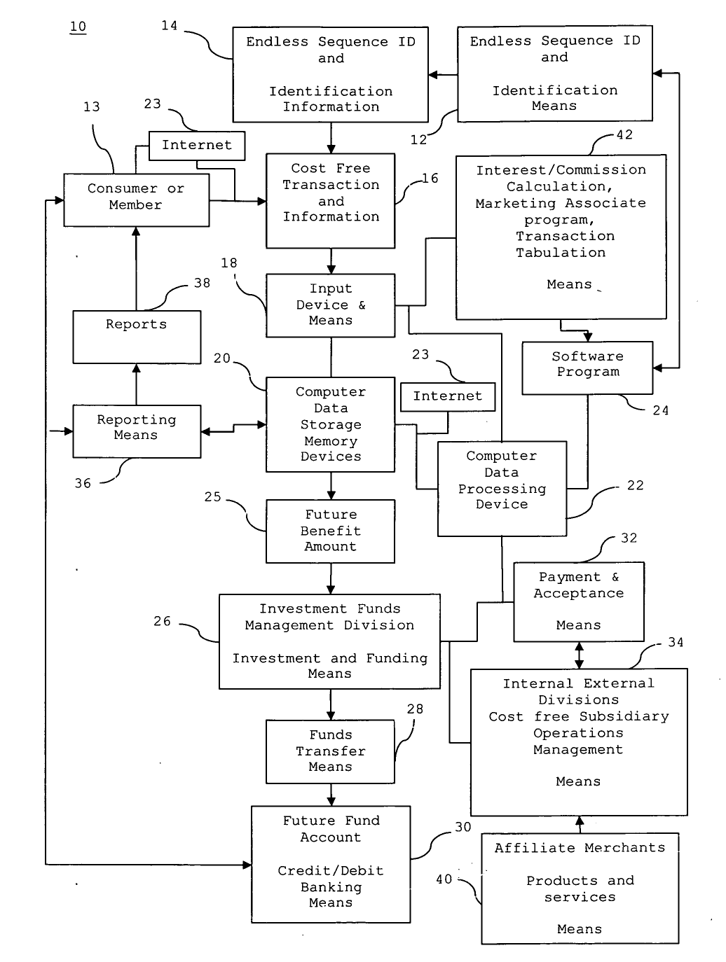

This application claims benefit of provisional application Ser. No. 60/675,894 filed on Apr. 29, 2005.

### FEDERALLY SPONSORED RESEARCH:

Not Applicable

### SEQUENCE LISTING OR PROGRAM:

Not Applicable

### BACKGROUND OF THE INVENTION—FIELD OF THE INVENTION

The present invention relates to a Cost Free Economics “maximum consumer self-interest” future benefits incentive system that comprises a computerized online system with means to provide transaction commission income to marketing associates as it harnesses maximum consumer self-interest creating cost free goods and services by providing future benefits comprised of an amount equal to or greater than the total consumer transaction amount tabulated to the consumers future fund account and there combined with interest benefits if any and subsequently converted to a monetary benefit at a future date providing for current maximum self-interest incentive and patronage motivation with cost free products and services.

More specifically, the present invention relates to providing the return to the consumer and or organization member as a future benefit on a future date the total amount of a purchase paid out by a consumer and or organization member to the organization and or affiliate merchants, individuals or other affiliated entities of the organization and to tabulate said amount and on or after a future date return to or credit the future fund account of the consumer and or organization member the total amount or a greater amount of the said transaction as a future benefit minus any organization determined and identified deductions, chargeback's or fees, if any, thereby inventing an innovative and novel method of providing product or services cost free to all users.

The present invention also relates to providing multi-generational levels of benefits by providing Cost Free Goods and Services to consumers and or organization members while engaging them in a mandatory, contained program that results in future financial benefit to them and their primary levels of heirs, primary levels of heirs as being assigns, spouse, children and grandchildren, on a future date or unspecified future dates and provides for a consumer option of combining organization services and methods of transaction to double or greater the benefit amount effectively doubling or multiplying by combination the said consumer transaction expenditure amount as a future benefit providing maximum consumer self-interest motivation for consumer patronage to participating merchants providing consumer benefits never previously attained and unattainable by any other means.

### BACKGROUND OF THE INVENTION—DISCUSSION OF PRIOR ART

A recent US Dept of Commerce report stated that Americans in 2005 spent more than they earned for the first time since The Great Depression. Globally people and nations are now faced with a serious negative financial savings deficiency that could seriously escalate due to various factors such as an aging population and skyrocketing health care costs to name just a few. From the earliest days of civilization economic processes have been searched for that could help reduce individual poverty with a means to increase individual wealth and savings with consistency while lowering the ever spiraling burden on government for social services.

The need exists to dramatically increase earnings for all consumers in order to mitigate the deficiencies of poverty, exorbitant health care costs and a national negative savings rate at the individual level. The means to be able to convert a lifetime of spending into a lifetime of savings and security would effectively double the effective buying power of the individual consumer to forever eliminate the circumstance of an individual negative savings rate and combat future security needs and individual poverty as well as be extraordinarily beneficial to business and government. The need exists to provide a program of long term mandatory savings which convert to future financial benefits at a future date when individual needs become most pressing. The recent US commerce department's reports trumpet a clear global alert that future needs with little or no individual savings has become today's reality.

Globally, government and business are also under increasing pressure from the effects of outsourcing of jobs and industries. The average person's perception that jobs are being outsourced because of the inability to produce products at home competitive in price to the lower cost of product available from low wage, unregulated manufacturers. Unregulated production methods contribute to everything from child and slave labor to global increases in pollution. Jobs are outsourced from one nation to the next displacing economies and causing tremendous capital reinvestments and losses as lower costs are sought and always leaving additional unemployed as local consumers. More and more consumers with less and less jobs to go around are the result. Formerly advanced manufacturing nations can not compete effectively with unregulated global economies supported by low wages and unregulated environmental protocol. These and other global economics factors also contribute to social unrest such as the current global concerns over immigration issues.

There is a need to develop economic processes that will help neutralize the inherent marketing advantage that low prices unfairly achieved impose on properly regulated industry. What is needed is a global economic innovation that would put even higher priced domestic made products on more equal footing in the eyes of the consumer. Price can be equally weighed and valued with future consumer benefits as an incentive motivator so that other factors such as quality, convenience and domestic manufacture can be part of the consumer buying decision process and patriotic support of domestic industry can be practiced without suffering economic loss to the consumer for patriotic support of domestic product in any nation.

The Internet has seen the emergence of free products or services as the cornerstone principal behind many new internet endeavors. The concept of making profit by giving your primary product or service away for free is the underlying principal of most successful internet business models. Even finance has its examples of structuring to gain free benefit. Reporter Allan Sloan in, “A Borrowing Deal Worthy of a Billionaire . . . Zero-Percent Interest? Warren Buffett Does Better Than That” The Washington Post, Sunday, Apr. 6, 2003, reports on Mr. Buffett's huge funding of hundreds of millions of dollars providing a substantial example of innovative financial economics successfully applied. There are examples of Internet businesses such as Google Inc., and Yahoo! Inc., successfully using free internet economics and providing free services as an incentive to gain and maintain online viewers while generating revenue through online advertising or some other service. Free internet economics has become the new standard for establishing and maintaining internet visitor loyalty for new and established internet ventures. These examples demonstrate successful application of “free economics” concepts but fail to deliver the enormous potential of cost free economics to the individual consumer. This invention successfully applies the concept of cost free marketing to any product or service that a price at the time of transaction can be established, in essence providing a method to make any product or service cost free creating the existence of cost free economics and providing its benefits to consumers globally.

In today's modern Internet economies there is an ongoing need for novel methods to increase consumer spending and consumer loyalty while also benefiting business by fueling economic growth to maintain strong domestic economies. Due to the fact that many products of the new Internet connected economy are digital in structure and are composed of electronic 1's and 0's which are easily duplicated and then distributed lends these products to instant piracy. A market and consumer solution is needed to motivate the consumer to choose the legitimate but more expensive product over cheaper pirated software, music and movies to name a few. An economic innovation is needed to help perpetually fuel economic growth and consumer spending while neutralizing negative saving rates, outsourcing and digital piracy. Cost free economics provides these needed solutions.

In order to attract and retain business customers, airlines, hotels, car rental companies, chain retailers, telecom providers, etc., have historically introduced frequent use programs that offer incentive programs, systems, rebates, coupons, awards of “frequent flyer miles” or other such incentives schemes based specific use or specific purchases such as on the distance traveled or use by that customer or rebate procedure or coupon redemption. Competition has forced airlines to modify the manner in which mileage was acquired to include travel related purchases by consumers. For example, the dollar-based cost of a ticket purchased may be awarded as mileage to a client account. In essence all prior related art provides for only some form of partial award or incentive of the total actual consumer expenditure transaction.

Within the past several years, credit card companies or other retailers both on and off line have co-branded credit cards in the name of the airlines and the credit card company where each dollar spent using the card is recorded as a mile of travel or point in the award program generating a monetary reward that is less than the initial consumer expenditure. In some form credit card companies offer partial direct savings for use of their card which is deposited in interest earning accounts or transferred directly back to the customer. In essence all prior related art provides for only some form of partial award or incentive of the total actual consumer expenditure transaction.

A wide variety of customer incentive programs have been developed in the past to motivate customers to make purchases from one or a plural of services or merchandise providers. These programs, such as coupon, rebate, awards, and prize programs were effective in attracting specific customer groups to conduct one-time purchases but, by in large, have varied levels of effect on the long term consumer self-interest of a majority of consumers collectively motivating customers to return to the same provider for future purchases. In essence all prior related art provides for only some form of partial award or incentive of the total actual consumer expenditure transaction.

This “future business” aspect impacting all consumers equally is an important part of an effective consumer self-interest incentive program. Another vital component of an effective incentive program is variety of products and services to choose from. Customers are diverse in their needs and want to have a large number of choices with regard to the products and services they buy from. In order to have such a variety, a large number of different providers and producers need to participate in the incentive program as affiliate merchants to provide this broad range of products and services and provide a minimum profit from each sale to the organization as required by the organization providing the cost free exchange.

All incentive systems endeavor to stimulate consumers to engage in behavior desired by the entity utilizing the incentive system. The marketing target of the incentive program is the customer and the entity employing or utilizing the incentive future benefits system is the merchant or organization, usually a provider of goods or services, who utilizes the incentive system to stimulate the customer into engaging in transactions for those goods and services and acquiring customer brand loyalty. Examples of incentive awards of prior art include free merchandise, discounted prices, cash refunds or credits, and the opportunity to win prizes such as merchandise, services, or vacation trips. However, an incentive award is sometimes as simple as the opportunity to participate in a transaction with the merchant which has features the customer may find beneficial. In essence all prior related art provides for only some form of partial award or incentive of the total actual consumer expenditure transaction.

One of the forms that an incentive benefit system can take is that of the merchant advertising to customers the possible benefits of entering into a transaction with the merchant. Usually, the transaction is a sale of goods or services and the benefits advertised are the particular advantages of the goods or services that the merchant would like to sell. The merchant may also advertise the benefit of his price for the goods or services relative to the price his competitors would charge. A drawback to conventional advertising is that the advertising must be paid for whether or not the advertising produces any transactions at all.

Another type of incentive benefit system involves the merchant allowing the customer to participate in a game of chance to which the merchant supplies the prize awards. Drawbacks of this type of incentive system include the need for the merchant to design the rules of the games in accordance with applicable legal restrictions and to design, publish, and distribute the playing pieces of the game to the customers. Another drawback is that the merchant must select the incentive award prizes and figure out a convenient way to award the incentive award prizes to the winners. Another further drawback is that the awarding of prizes may be required regardless of whether any transactions were made with the customer and regardless of the value of transactions that were in fact made. Other disadvantages include problems associated with the validation of winning game pieces, disputes over eligibility and winning, and problems related to the presentation of the incentive awards such as unavailability of or damage to the prizes before presentation occurs.

Another type of incentive program uses the award of merchandise selected from a catalogue as an incentive award to the customer to engage in transactions with the merchant. In this type of incentive system, the customer is awarded a number of points for a transaction. The number of points awarded may depend on the monetary value of the transaction. The number of points awarded may also depend upon the frequency of transactions the customer has with the merchant or the time period in which the transactions are conducted. Various means have been used to keep track of and to validate the number of points accumulated by each customer. Examples of such tracking and validation means include stamps, stickers, tickets, and punch cards. However, catalogue merchandise-based incentive systems have many drawbacks. Among these drawbacks is the need for the merchant to select merchandise that will be awarded and to design, publish, and distribute catalogues. Other drawbacks include the need for the merchant to obtain, warehouse, and distribute the incentive award merchandise, and to deal with faulty award merchandise, overstocked and under stocked award merchandise conditions.

Another type of incentive system involves the merchant issuing coupons which customers can use beneficially in a transaction with the merchant. The coupon-based incentive system often is used in conjunction with advertising. The coupons may allow the customer to pay a lower price for the good or service or to obtain additional merchandise or services. However, drawbacks of coupon-based incentive systems include the fact that the management of the system requires the designing and issuance of the coupons as well as the collection, verification, redemption, handling, storage, and final disposal of the coupons. Another disadvantage is that redemption of the coupons at the time of the transaction can significantly prolong the time the transaction takes to occur thereby consuming valuable time of the merchant, the customer, and other customers who are in line behind the customer who is redeeming the coupons. Another disadvantage is that the finding, cutting out, sorting, organizing, and carrying activities accompanying the redemption of coupons provides countervailing disincentives to the customer to participate in a coupon-based incentive system.

Still another type of incentive benefit system involves the merchant awarding a credit to the customer that may be used by the customer toward later transactions with the merchant. The amount of the credit awarded may depend on the monetary value of the transaction, the frequency of transactions, or other transactional characteristics such as the specific goods or services involved in the transaction. This type of incentive benefit system has the drawback that the customer is restricted to redeeming the credit benefit only as part of a transaction with that particular merchant, thereby reducing the attractiveness of the incentive benefit to the customer.

In another type of incentive benefit system, the merchant awards a flat cash payment to the customer when the customer attains certain goal that is related to transactions the customer has with the merchant. A drawback to this type of incentive benefit system is that the cash award may be quickly spent leaving nothing to remind the customer of the incentive benefit or of the merchant.

Some incentive systems use trips to vacation spots as incentive awards. There are drawbacks to the use of vacation trips as incentive awards. One drawback is that the cost of vacation awards usually precludes the possibility of making such an award to each customer for each transaction with the merchant. Another problem is the difficulty in selecting the location, duration, means of travel, and accommodations for the vacation trip.

Increased life expectancies along with predictions of the insolvency of the Social Security system in the near future and increased healthcare costs and poverty has heightened the awareness in many people about the need to accumulate funds for their future years. The general fall off in individual savings rate and concern over future solvency of social security has heightened the concerns of consumers for their future security. Prior art incentive benefit systems have utilized as an incentive only the partial fulfillment of the original customer transaction expense and sought to motivate by only fulfilling either the immediate or long term needs of the customers. The need exists to provide an incentive future benefits program of innovative social engineering providing market solutions to existing problems of savings and social issues. Thus, it is clear that what is lacking in the art is a incentive future benefits system which, while overcoming many of the drawbacks of prior art incentive systems, utilizes total customer self-interest to save everything spent and more, fulfilling a consumers long term future benefit need to save with every purchase made and to save and or benefit the total amount spent or greater fulfilling in a new and novel way the consumers desire to receive maximum benefit for consumer loyalty. Providing for the consumers future security with a novel benefit comprised of the total amount spent or greater translates to maximum incentive for present day unshakable consumer self-interest loyalty and maintains continued consumer future loyalty at previously unrealizable maximum levels. Providing means for additional current income from commissions of all transactions made by members sponsored and registered by a sponsoring marketing associate organization member further enhances consumer to incentive maintain patronage.

From the above examples it is apparent that prior art incentive systems focus on returning only a partial amount of the total of a consumer transaction as an incentive for the consumer to patronize the merchant of a incentive system and are split in focus between short term or long term benefits to the consumer. However, consumers have both short and long term motivating interests that determine a consumer's loyalty to an incentive program. Factors such as price, use and varied other self-interest as well as future security interests influence impulse and deliberated purchases. However, primary consumer motivation to participate in an incentive program is determined by consumer self-interest.

The fulfillment of future benefits directly tied to the future return of present day spending of the total amounts spent and or greater combines both short and long term consumer interests and focuses and then maintains this self-interest at maximum levels that grows with every new cost free purchase with a like increase in future benefits anticipated. This every growing future benefit of the future benefits incentive program provides a principal maximum incentive to motivate a consumer to utilize the particular benefit program and establish enduring consumer loyalty to a participating merchant.

Maximum consumer self-interest motivation to participate in an incentive future benefit program to continue to patronize a participating merchant, both short and long term, is achieved upon the consumer and or organization members' awareness that the total amount spent cost free is also saved in like amount or greater as a future benefit. The inherent and primal need the consumer and or organization member has to receive the best achievable price in a transaction and to provide for future security and the future of loved ones is a particularly powerful self-interest motivator that is harnessed wholly and maintained by this invention.

Increased life expectancies along with predictions of the future insolvency of the Social Security system have heightened the awareness of consumers about the need to accumulate funds for the future but what has been lacking is a fairly effortless, consumer friendly, mandatory savings method based on sound economic principle and proven mathematical calculation. The economic reality is that the consumer achieves best purchase price by saving all that is spent in a transaction and achieves future security when substantial savings are accumulated for a future date. This invention provides the consumer with unparalleled price and self-interest satisfaction and desired future security as it also stimulates greater amounts of spending building an ever stronger economy. This could one day be regarded as one of the greatest economic innovations of our time.

There are a variety of rewards and customer incentive programs that benefit individual and corporate consumers by providing incentive benefits and do contribute to help build individual and corporate wealth by providing incremental reductions in transaction cost. Most incentives are calculated from the price of a product or service or the transaction or purchase price and are limited to a portion of the transaction amount and result in a benefit to the customer of a partial amount of the total transaction amount of a product or service paid out in various ways. However beneficial these partial benefits with calculated limitations have been to customers, sponsor merchants and business stimulation, they are partially calculated benefits and incremental incentives. The need exists for a far more comprehensive solution that removes calculated limitations and other limitations of current incentive and benefit systems and provides short term incentives, long term benefits and multi-generational security with maximum self-interest motivation for the consumer. Today's solutions and common practices to correct the shortcomings of social issues such as health care, insurance, individual poverty and job outsourcing, to name a few, have centered on charity and government efforts for the continued lack of a viable market driven economic solution to overcome these social ills. Today's connected global economy is built on the reliance of ever increasing returns from almost pure margin. However, this high margin comes from easily pirated digital intangible electronic products. These industries currently are reliant to utilize this high level of margin to negate the losses to piracy.

Prior art does not provide for a consumer to utilize relatively small amounts of reward points in any manner. In addition, a consumer often can only redeem points in an airline-related manner (i.e. to obtain a free ticket or upgrade from coach to first class). This prior art does not recognize the need for a consumer to exchange reward points for non-travel related goods, and in particular renders relatively small numbers of points useless. For example, a consumer who does not travel often may have 500 points in United Airlines, 700 points in USAir, and 1000 points in TWA, each of which is relatively useless in prior art. What is desired therefore is a system where the total expenditures of a customer, whether the expenditure is large or small and whether it is made across various product or service types or different participating merchants are tabulated and returned to the user as a future benefit without loss due to incentive programs limitations.

U.S. Pat. No. 5,774,870, FULLY INTEGRATED, ON-LINE INTERACTIVE FREQUENCY AND AWARD REDEMPTION PROGRAM, issued to Netcentives, Inc. on Jun. 30, 1998. The '870 patent provides a system whereby the user can make purchase of products over the Internet and receive award points, which are stored in an associated database. The user can subsequently view an award catalog to determine which awards he may be able to redeem based on the number of points in his account. Such awards, in essence provide for only some form of partial award or incentive of the total actual consumer expenditure transaction.

U.S. Pat No. 5,991,736, A PATRONAGE INCENTIVE AWARD SYSTEM INCORPORATING RETIREMENT ACCOUNTS AND METHOD THEREOF, issued to Ferguson on Nov. 23 1999. The '736 patent provides a system and method whereby a monetary award that addresses a customer's long term need to provide for his retirement security is made to a customer's retirement account as incentive for the customer to participate in a transaction with a merchant sponsor for the merchant sponsor's goods or services. Specifically, this invention relates to a patronage incentive award system in which a computerized system calculates and transfers to a customer's retirement account a monetary incentive award for each transaction conducted with the merchant sponsor of the incentive award. Also this invention comprises the step of calculating an incentive award amount and of debiting an account of the merchant sponsor for an amount which is at least equal to the incentive award amount for the transaction to the customer's retirement account. Such a system thus, provides for a partial award or incentive of the total actual consumer expenditure transaction and imposes the total value of the incentive award on the amount transferred from the participating sponsor.

The ClickRewards program site appears to operate in the same fashion as that described in the '870 patent; i.e. it allows users to gain points (called “ClickMiles”) for making an online purchase of a product through an associated web site. For example, ClickMiles may be awarded for a purchase of Gap products at the Gap web site. The ClickMiles can ultimately be redeemed for frequent flyer miles, for example at one of several major airlines. Such a system thus, provides for only partial award or incentive of the total actual consumer expenditure transaction.

U.S. Pat. No. 6,947,898 SYSTEM FOR ELECTONIC BARTER, TRADING AND REDEEMING POINTS ACCUMULATED IN FREQUENT USE REWARD PROGRAMS issued on Sept. 20, 2005. The '898 patent describes an incentive reward system of points accumulation and redemption program where the accumulated points are used to purchase items. Such a system thus, provides for only partial reward or incentive of the total actual consumer expenditure transaction.

U.S. Pat. No. 5,794,210, ATTENTION BROKERAGE, issued on Aug. 11, 1998 to CyberGold, Inc. The '210 patent describes a system that makes immediate payment to a user for paying attention to an advertisement or other “negatively priced” information distributed over the Internet. A special icon or other symbol displayed on a computer screen may represent compensation and allow users to choose whether they will view an ad or other negatively priced information and receive associated compensation. The points accumulated can then be used to purchase “positively priced information” or products.

The CyberGold web site, www.cybergold.com, describes an “earn and spend” community, in which users earn “cash” online, for example by visiting a portal site. The earnings can then be used to make online purchases, such as software.

U.S. Pat. No. 5,025,372, SYSTEM AND METHOD FOR ADMINISTRATION OF INCENTIVE AWARD PROGRAM THROUGH USE OF CREDIT, issued on Jun. 18, 1991 to Meridian Enterprises, Inc. The '372 patent describes an incentive award program in which credit is awarded to participants based on the participant meeting a designated level of performance under the system. This patent does not teach the ability to increase the reward points in a user's account by redeeming points from a pre-existing account such as a frequent flyer mileage program. Such a system thus, provides for only partial award or incentive of the total actual consumer expenditure transaction.

U.S. Pat. No. 5,991,736, PATRONAGE INCENTIVE AWARD SYSTEM INCORPORATING RETIREMENT ACCOUNTS AND METHOD THEREOF, issued on Nov. 23, 1999. The '736 patent describes an incentive award system in which a monetary award is made to a customer's retirement account as incentive for the customer to participate in a transaction with the sponsor for sponsor's goods or services. The incentive awarded to participants is based on a partial incentive award amount calculated from the transaction amount. Such a system thus, provides for only partial award or incentive of the total actual consumer expenditure transaction. Existing rewards and incentive programs are structured on partial rewards and incentives that are made available or are returned to the consumer as rebates or partial savings. Many existing rewards and incentive programs have imposed limitations and or require specific procedures to be followed such as collecting and returning related coupons or redeeming credits for cash or products. Existing long term incentive programs are also based on partial savings or rebates in contrast to this invention which provides the system and method to return the total cost of product or service to the consumer.

The prior art is based on partial incentives which result in limited, partial consumer self-interest motivation to any particular incentive program in contrast to the overwhelming self-interest motivation generated by a consumer saving the entire amount and or more of a cost free purchase as a benefit at the time of purchase. This is the pinnacle of consumer self-interest incentive. By impacting all consumers equally on every cost free purchase made without exception the consumers' self-interest is established as the primary motivator. It is the consumers' ultimate self-interest both short and long term to save the entire purchase cost of a transaction as a future benefit and receive cost free products and services.

The solutions of charity and government effort for correcting social issues and individual poverty remain necessary but are only temporary solutions at best and a long term sound economic process is needed to affect a permanent solution to a national negative saving rate and individual poverty.

Thus, it is clear that what is lacking in the art is an future benefits incentive system which overcomes many of the drawbacks of prior art incentive systems by providing for the return to the consumer of the total purchase amount of a consumer transaction, in contrast to the partial benefits of prior art, and combines the consumers short term interests for maximum value at date of purchase with the long term interests of the consumer for future security and mandatory savings and or multi-generational benefits and also provides additional short and long term benefits as an individual income opportunity that is structured on individual equality and effort providing current as well as future individual income for the consumer as a marketing associate organization member

### BACKGROUND OF INVENTION—OBJECTS AND ADVANTAGES

It is therefore an object of the invention to provide the system, method and means to provide cost free goods and services to consumers, buyers and organization members all identified as users by converting the entire transaction amount of a purchase to a future benefit.

It is therefore an object of the invention to provide a voluntary system and method of transferring or converting the product or service cost and various transaction costs of purchases and cost free purchases to mandatory savings for a return of a equal or greater amount of the expenditure or purchase amount paid by the user to the user at a future date or unspecified date of the total cost of product or service expended by user at the time of the cost free purchase.

It is therefore an object of the invention to provide a program of long term mandatory savings securing certain and fixed amounts of future financial benefits to the user and their primary levels of heirs, (spouse, children and grandchildren).

It is another object of the invention to provide the system and method to accumulate and fund the return, at a future or unspecified date, the total certain cost of product or service of each cost free purchase to the user or organization member.

It is another object of the invention to provide the method and system to convert a lifetime of participating goods and services expenditures into long term mandatory savings and benefits securing certain and fixed amounts of future financial consumer benefits to the user or organization member.

It is another object of the invention to provide the system and method to make eligible as cost free product or service any product or service sold by the organization to user or organization member whose cost can be determined at the time of transfer to the user or organization member, “at a certain value cost amount” and whose sale to the user or organization member generates certain minimum profit to the organization.

It is another object of the invention to provide the system and method to make eligible as cost free product or service any product or service sold by affiliate merchants of the organization, to the user and organization member, whose cost can be determined at the time of transfer to the user or consumer, “at a certain value cost amount” and whose sale to the user or organization member generates certain minimum profit to the organization.

It is another object of the invention to provide the system and method to fund future liabilities of certain cost's for a future date and utilizes a extendable time component to adjust the payout date through the needed funding period.

It is another object of the invention to provide a system and method to create and secure totally collectible debt instruments internally secured within the organization by the certain costs due back to the consumer or organization member.

It is another object of the invention to provide a donation fund with a future fixed or extendable or no return date of the donations.

It is another object of the invention to provide the cross platform messaging and identification system utilizing the endless sequence dynamic identifier and access code.

It is another object of the invention to mitigate against the negative impact of digital piracy and outsourcing of jobs and services by providing total benefit from a transaction.

It is another object of the invention to reduce or minimize cost of product or service as the primary motivator to outsource manufacturing to achieve lower cost to the consumer providing the consumer with choice of quality, or other factors in addition to cost allowing for patriotic support of domestic industry while still being economical and beneficial to the consumer.

It is another object of the invention to provide the system and method to relieve pressures on government for service and health care expenditures by converting a lifetime of participating consumer goods, services, health care, and/or other expenditures into a long term mandatory savings program securing certain and fixed amounts of future financial benefits to the consumer.

It is therefore an object of the invention to provide the system and method with means to search and or list online and off-line for cost free product and cost free service providers and or provide cost free goods and services to consumers and or organization members all identified as users.

It is therefore an object of the invention to provide a voluntary system, method and means of transferring or converting the product or service cost and various transaction costs of cost free purchases to mandatory savings and or future benefits for a return of a equal or greater amount of the expenditure or purchase amount paid by the consumer and or organization member to the consumer and or organization member on or after a future date or unspecified date of the total cost of product or service expended by user at the time of the cost free purchase.

It is therefore an object of the invention to provide the program of long term mandatory savings and or securing certain and fixed amounts of future financial benefits to the user and their primary levels of heirs, (spouse, children and grandchildren).

It is another object of the invention to provide the system, method and means to accumulate and fund the return, on or after a future or unspecified date, the total certain cost of product or service of each cost free purchase to the consumer and or organization member with or without deductions, if any.

It is another object of the invention to provide the method and system to convert a lifetime of participating goods and services expenditures into long term mandatory savings and or future benefits securing certain and fixed amounts of future financial consumer benefits to the consumer and or organization member.

It is another object of the invention to provide the system and method to make eligible as cost free product or service any product or service sold by the organization to the consumer and or organization member whose cost can be determined at the time of transfer to the user or organization member, “at a certain value cost amount” and whose sale to the consumer and or organization member generates certain minimum profit to the organization.

It is another object of the invention to provide the system and method to make eligible as cost free product or service any product or service sold by affiliate merchants of the organization, and or other entities to the consumer and or organization member, whose cost can be determined at the time of transfer to the user or consumer, “at a certain value cost amount” and whose sale to the consumer and or organization member generates certain minimum profit to the organization.

It is another object of the invention to provide the system and method to provide for the position of marketing associate as an organization independent contractor position to any eligible organization member.

It is another object of the invention to provide the system and method for a economic transaction or other transactions that return as a benefit the entire amount of the transaction or greater to any entity or individual or purchaser or seller and or other party and to include or not include a commission to purchaser, seller or other party.

It is another object of the invention to provide the system, method and means for a commission payment to an organization marketing associate for eligible cost free transactions made by all organization members directly registered as a new member of the organization by that marketing associate.

It is another object of the invention to provide the system and method for a commission payment to an organization marketing associate on any eligible cost free product or service and or any product or service sold by the organization and or affiliate merchant of the organization, to an eligible consumer and organization member, whose cost can be determined at the time of transaction to the user or consumer, “at a certain value cost amount” and whose sale to the consumer or organization member generates certain minimum profit to the organization.

It is another object of the invention to provide the system and method to fund future liabilities of certain cost for or after a future date and utilize the extendable time component to adjust the payout date through the needed funding period.

It is another object of the invention to provide a system, method and means to create and secure totally collectible debt instruments internally secured by the certain cost benefits due back to the consumer or organization member on or after a future date.

It is another object of the invention to provide the system and method to provide a donation fund with a future fixed or extendable or no return date of the donations.

It is another object of the invention to provide the system, method and means for a cross platform messaging and identification system utilizing the endless sequence dynamic ID and access code.

It is another object of the invention to provide the system and method to mitigate against the negative impact of outsourcing of jobs and services on the organizations nation and workers.

It is another object of the invention to provide the system and method to reduce or minimize cost of product or service as the primary motivator to outsource manufacturing to achieve lower cost to the consumer and or organization member providing the consumer and or organization member with choice of quality, or other factors in addition to cost allowing for patriotic support of domestic industry while still being economical and beneficial to the consumer.

It is another object of the invention to provide the system and method to relieve pressures on government for service and health care expenditures by converting a lifetime of participating consumer goods, services, health care, and or other expenditures into a long term mandatory savings and or future benefits program securing certain and fixed amounts of future financial benefits to the consumer.

It is another object of the invention to provide the system and method to transform and or convert the total costs and expenditure amounts of transactions to savings and or future benefits.

It is therefore an object of the invention to provide the system and method to transfer social expectations and responsibilities, cost of health care, and personal saving, to name a few, with minimum effort, to the individual and the private sector.

It is therefore an object of the invention to provide the system and method which can be continuously expanded by a member organization, corporation, individual, other entity, and or government entity to provide for all types of cost free goods and services while creating and securing completely collectable debt instruments which also can fund the cost free process.

It is therefore an object of the invention to provide a system and method of cost free exchange by the cost free cycle from the sale of product and or service to the funding of the “certain cost liability” and or future benefit and to return to the consumer and or organization member the total certain cost future benefit for each specific cost free purchases minus any deductions, if any, and or interest additions, if any.

It is therefore an object of the invention to provide a system and method for issuing and securing fully collectable loans, credit cards and or creating and securing 100 per cent completely collectable internal debt instruments for the organization by internally securing debt repayment with the internally secured and maintained established certain value cost future benefit monies which are secured by the through the end of the cost free cycle.

It is therefore an object of the invention to provide a system and method to fund and return the certain cost future benefit of cost free goods or services on or after a unspecified date or after a stated future date utilizing the flexible and or extendable time period component and due date to adjust the actual payout date as needed through the needed investment and or earning period as determined by the organization to fund the return of the total certain cost future benefit amount. This certain cost future benefit amount being the entire cost free transaction amount of all monies collected from the consumer or organization member for goods and or services provided to the consumer and or organization member by this method and or through the organization, minus justified deductions at the discretion of the organization plus interest additions if any.

It is therefore an object of the invention to provide a system and method for funding a future benefit and or liabilities of certain cost, separately and or consolidated in an individual account and or grouping of individual accounts which may be due on or after a specific date, and or within a specific date range, and or on a unspecified date after a stated due date, with current funds of a lesser amount that is less than the specific future certain benefit and or certain cost future benefit and or certain liabilities and or certain cost future benefits grouped into an account and or grouping of accounts and the funding of a future benefit of certain cost and or certain cost future benefits for a future date utilizing a flexible and or extendable time component and due date to adjust the actual payout date as needed through the needed investment and or earning period as determined by the organization to fund the future benefit of certain cost and or future benefit amount.

It is therefore an object of the invention to provide a unique messaging and identification global address directory and or a dynamic, permanent record, endless sequence access code system with a member account number attached to the end of a dynamic endless sequence code when needed.

It is therefore an object of the invention to provide a system and method for dynamic addition to the sequence of the endless sequence ID and access code system while maintaining identification of user and or member for cross platform messaging, internal account access and various levels of authorized access.

It is therefore an object of the invention to provide a system and method for a messaging center for all users to be able to communicate across all sites, paid or free and or platforms and or, as example, all internet personals sites and or internet dating sites without restriction and or includes and or provides for the use of all physical addresses as sequence component alias addresses and or phone numbers present and future as sequence component alias addresses and allows any user and or consumer and or organization member to convert and or transpose them and or any user name and or alias and or address on any internet site and or any email address, be it a paid member site and or open member site and or any physical address and or series of numbers into a organization identifiable sequence component alias name or address and or fixed address and or user name that a message can be sent to through this Global Address Directory platform for the purpose of maintaining dynamic unique identification of the consumer and or organization member through the various stages of the user, member and final beneficiary cycles and being able to send messages cross all platforms to any name, user name, number or physical address and/or any site, or series of numbers bypassing all restrictions and or paid member restrictions imposed by paid member sites to send and receive messages by unpaid members and/or any restrictions to send messages to and or for any identifiable alias name or address and/or fixed address and or user name of any site.

It is therefore an object of the invention to provide a system and method of identifying users and or members as they progress through various stages of interaction with the organization or other entities by periodic and or endless additions to the endless sequence identifier and or code.

It is therefore an object of the invention to provide a system and method to create and secure completely collectable credit cards and debt instruments secured by the individual consumer's future fund tabulated future benefit amounts.

It is therefore an object of the invention to provide a system, method and means to create and secure a membership online and or offline identification system and personal identification pay services card utilizing the endless sequence dynamic identifier and access code identification information for identification means and pay services transactions providing the consumer option for combination of multiple benefit transactions doubling and more certain transactions.

It is therefore an object of the invention to provide the system and method of operating an incentive future benefits system providing the system for any one or any entity to online or off-line list for a fee and or promote for a fee and or on line or off line to list for free and or promote for free to sell any product or service and or for the consumer and or organization member to search purchase from non organization sites or entities and to convert any resulting transaction to a cost free transaction providing for the return to the consumer of the total transaction amount or a greater amount as a future benefit amount minus any deductions if any plus additional calculated interest if any.

It is therefore an object of the invention to provide a system and method to provide cost free goods and cost free services to users, consumers and or organization members as individuals or affiliate merchants or corporate entities or other entities or government entities worldwide and or to provide and or sell goods and or services through the organization and or through affiliate merchants and or through other entities to consumers and organization members and to return to and or credit to the account of the consumer and or organization member on or after a future date and or on a specific date, and or within a specific date range, and or on an unspecified date after a stated due date the entire amount, minus any deductions if any plus any interest if any, of all established certain value monies collected from the consumer or organization member for goods and or services provided to the consumer and or organization member by this invention and or through this program and to insure a means of purchasing a zero coupon note and or any other financial instrument and or investment that is designed, and or identified and organization qualified to fund the payment, in full or in part, to the consumer and or organization member of a certain value future benefit and or certain value future liabilities in account composed of in specific part or in whole of a certain value benefit and or certain value liabilities in an account and or grouping of accounts and thereby provide fully for the repayment and future cost of the certain value benefit and or certain value liabilities in specific part or account entirety as a whole utilizing the time component of a flexible and or extendable as needed actual payout date and a means for operating a marketing associate program where each registered organization member can earn and be paid to their future fund account or by check or electronic transfer a marketing associate commission income, as determined by the organization and or any other means, from all cost free transactions and or other commissionable transactions made with the organization and or affiliate merchants and or other entities by any organization member that was recruited and registered as a new organization member by that marketing associate member

It is therefore an object of the invention to provide a system, method and means to accept and or receive a certain value amount from a user, consumer and or organization member for a delivered product and or service while expending and or paying a lesser amount for the product and or service to include by example but not be limited to converting gambling, games of chance and or any other entertainment expenditures to savings and future benefits.

It is therefore an object of the invention to provide a system and method to accept and or receive a referral commission from an affiliate merchant and or other entities for referring the consumer and or organization member to the merchant or entity for a transaction of delivered product and or service.

### SUMMARY OF THE INVENTION

In accordance with the present invention, there is provided the system and method to provide cost free goods and services to consumers and or organization members while engaging them in a mandatory, contained program that results in savings and or future financial benefit to them and their primary levels of heirs, primary levels of heirs as being spouse, children and grandchildren, while also mitigating the negative impact of outsourcing on our country and our workers. It will minimize cost of product or service as the main reason to justify outsourcing to reduce those costs. Unlike existing rewards and incentive programs that are structured on partial incentives with primarily either short or long term incentive, this invention is based on the return of the total cost of product or service, and or a greater amount, to the consumer and or organization member at a future date with both short and long term benefits and maximum consumer self-interest motivation and or multi-generational future benefits.

The high cost of producing quality products or services at home while remaining competitive in a global marketplace that has become price driven to outsourcing is of primary national concern. The continued trend to outsource manufacturing has extended to the service industries as well and could be headed to crisis levels as more jobs are displaced to low wage, unregulated economic zones. By mitigating the cost factor to the consumer and minimizing cost as a main economic consideration, the primary motivating factor in the purchasing decision process of a consumer can be focused on quality of product or service and patriotic support of domestic industry. This change of primary focus from cost of product benefits industry and strengthens the nation through the process of patriotic support of national interests while at the same time is economical and beneficial to the consumer.

In simple language the consumer and or organization member under this invention and by this method will convert a lifetime of participating consumer goods expenditures and or services expenditures and or entertainment expenditures and or health care expenditures, and or other expenditures into a long term mandatory benefits program securing certain and fixed amounts of saving and or future financial benefits while providing commission income opportunity to organization members.

This invention is a method and system of financial, economic and social engineering targeting the problem of high cost of product and services to the individual as well as to corporate entities and government. With little effort, it transforms costs and expenditures to savings and or benefits. Social responsibilities and expectations, personal saving responsibility and even cost of health care is painlessly and with minimum effort transferred to the individual and the private sector relieving social spending pressures on government due to the fact that it is a voluntary method of transferring cost to mandatory benefits for a full return on or after a future date. This method and apparatus comprises means to allow continued expansion by the member organization and or corporation and or individual and or other entity and or government entity to provide for all types of cost free goods and or cost free services while creating and or securing completely collectable debt instruments collateralized internally with the members' own future fund account.

This invention is a method and apparatus for providing cost free goods and services to participating buyers and sellers and or selling goods and or services directly by the organization or through affiliate merchants and or other entities to consumers and or organization members or other entities. More specifically, the invention to provides the system and method for an economic transaction or other transactions that return as a benefit the entire amount of the transaction or greater amount to any entity or individual or purchaser or seller and or other party and to include or not include a commission to purchaser, seller or other party. The present invention relates to providing for the return to the consumer and or organization member as a future benefit the total of all certain monies of a Cost Free purchase paid out by a consumer and or organization member and collected by the organization or collected by a affiliate merchant or other affiliated individuals or entities of organization and to return to and or credit to the future fund account of the consumer and or organization member on or after a future date the total amount or a greater amount of the cost free transaction purchase as a future benefit minus any organization determined and identified deductions, chargeback's or fees, if any.

The present invention also relates to providing multi-generational levels of benefits by providing Cost Free Goods and Services to consumers and or organization members while engaging them in a mandatory, contained program that results in future financial benefit to them and their primary levels of heirs, primary levels of heirs as being assigns, spouse, children and grandchildren, on a future date or unspecified future dates. These benefits are composed of and include the total amount or greater of cost free expenditures made by the consumer and or organization member which are then tabulated and posted to an account identified as the consumer and or organization members' future fund account by the organizations online computer system.

This invention also relates to a consumer and or organization members' maximum self-interest and loyalty incentive future fund by which a computerized system is reported to and or collects and tabulates the total purchase amount of the consumer and or organization members Cost Free expenditures and posts each individual transaction purchase total to the consumer and or organization members future fund account and transfers to the consumer or assigns each transaction amount as released by the organization.

The present invention also provides for the system, method and means for operating and funding the future fund system whereby the funding of a future benefit of certain cost for a future date comprising the method of the extendable time component that adjusts the future payout date through the needed funding period providing for the consumer or organization members' future fund account to be funded at a future date and or on unspecified future dates. The present invention also comprises the means and method of cross platform messaging and an identification system comprising and utilizing endless sequence dynamic identification identifiers and access code allowing the accurate internal tracking of future fund accounts to the consumer and or organization member and beneficiaries and assigns.

Examples of the invention to include but not be limited to concepts such as cost free and or risk free wagering, casino gambling, online gambling, entertainment, tickets and or season tickets, travel, lodging and other transactions provided to participating consumers and or organization members while also creating fully organization secured collectable internal financial debt instruments which can be used to fund the process are demonstrated to present the fact that even entertainment industries can contribute to consumer and or organization members future benefits and security.

This invention, method and apparatus easily converts even gambling loss and or expenditure into savings and or long term benefits. It transposes the moral issue of gambling to a meaningful socially responsible method of mandatory savings. One such method example would be the casino and or online casino issues for cash or cash value transactions no cash value casino chips and or no cash value play credits that would have no cash redemption value but would be playable for winnings in cash or cash value credits at that casino and or online casino and or other participating organizations. The consumer and or organization member would play out all acquired chips or play credits at that date and or other future date and be paid out any winnings as they happen. The original expenditure or the losses at the discretion of the casino will be returned to the consumer and or organization member at a later date as part of the mandatory cost free benefits process. This method allows people to enjoy risk free and or cost free entertaining experiences of wagering, entertainment, and or consuming at the same time as engaging them in mandatory saving. The outlined example not to limit the use of this invention to a specific game of chance, gambling or entertainment process or method.

This invention applied to the music and film industry is a market solution for the piracy problem. It would allow for the download and or product delivery of cost free music and movies to the consumer who would acquire the music and film product cost free. This is a market solution with social benefit for what is now an expanding market problem. With stern enforcement by government of anti-piracy and copyright laws in these markets combined with availability and consumer access to acquire these music and film products cost free under this invention. The invention provides a market solution comprising self-interest incentive and motivation to impact the piracy markets in a major way.

Any product or service whose cost can be determined at a certain value cost amount at the time of transaction with the consumer and or organization member can be converted to a cost free transaction under this invention and with this method. The established certain value cost is received from the consumer and or organization member. A portion of the funds is utilized and or secured internally by the organization through certain proven investment programs and means. The certain value cost future benefit minus any organization owned member debt and or fees, if any, is returned on or after a future date to the consumer and or organization members future fund account including additional interest benefit if any, completing the cost free cycle.

This invention is also a method and apparatus for issuing and securing fully collectable loans, credit cards, pay service and identification cards and or creating and securing 100 per cent completely collectable internal debt instruments for the organization by internally securing debt repayment with the internally secured and maintained established certain value cost monies which are secured by the organization and are returned to the consumer and or organization member at the end of the cost free cycle as a future benefit. It provides the method for cost free goods and cost free services to be delivered to consumers and or organization members as individuals or corporate or other entities or government entities and or selling goods and or services to consumers and or organization members and by providing for the return to the consumer and or organization member of all certain value cost monies paid out under this invention and by this method and or apparatus by the consumer or organization member for the goods and or services received and to return to and or credit to the account of the consumer and or organization member at a future date and or on a specific date, and or within a specific date range, and or on an unspecified date after a stated due date utilizing the flexible and or extendable time period component and due date to adjust the actual payout date as needed through the needed investment and or earning period as determined by the organization to fund the return of the certain cost amount future benefit. This certain cost future benefit amount being the entire amount of all monies collected from the consumer or organization member for goods and or services provided to the consumer and or organization member in a cost free transaction by this method and through the organization minus justified deductions if any and added interest if any, as determined by the organization.

Also, a method, apparatus and means for funding a future benefit and or liabilities of certain cost, separately and or consolidated in an individual account and or grouping of individual accounts which may be due on a specific date, and or within a specific date range, and or on a unspecified date after a stated due date, with current funds of a lesser amount that is less than the specific future certain benefit and or certain liabilities grouped into an account and or grouping of accounts and the funding of a future benefit of certain cost for a future date utilizing the flexible and or extendable time component and due date to adjust the actual future fund payout date as needed through the needed investment and or earning period as determined by the organization to fund the future certain cost benefit amount.

The apparatus comprises a unique messaging and identification global address directory that comprises and utilizes a dynamic, permanent record, endless sequence of identification identifiers created dynamically access code system with a member account number attached to the end of the dynamic sequence code when needed. The system allows dynamic addition to the sequence while maintaining identification of user and or member for cross platform messaging, internal account access and various levels of authorized access. It provides for a messaging center for all users to be able to communicate across all sites, paid or free and or platforms and or as example all internet personals sites and or internet dating sites without restriction and or includes and or provides for the use of all physical addresses as sequence component alias addresses and or phone numbers present and future as sequence component alias addresses and allows any user and or consumer and or organization member to convert and or transpose them and or any user name and or alias and or address on any internet site and or any email address, be it a paid member site and or open member site and or any physical address and or series of numbers into a organization identifiable sequence component alias name or address and or fixed address and or user name that a message can be sent to through this global address directory platform for the purpose of maintaining dynamic unique identification of the consumer and or organization member through the various stages of the user, member and final beneficiary cycles and being able to send messages cross all platforms to any name, user name, number or physical address and or any site, or series of numbers bypassing all restrictions and or paid member restrictions imposed by paid member sites to send and receive messages by unpaid members and or any restrictions to send messages to and or for any identifiable alias name or address and or fixed address and or user name of any site.

An example of the endless sequence code use, one of many uses to show as an example but not limited to, would be as follows: User name of an unknown person on restricted site is a person that you would like to send a message to. This person, Jane Doe has various user names on various sites as outlined below:
Example Persons Name: Jane Doe
Phone: 804-999-5555
Address: 6556 Grace St, Richmond Va., 23230

Account No: 99999xyz
User name: lovelygirl Restricted site name: GlobalMatchFree.com
User name: violet Restricted site name: WorldWideMatchFree.com
User name: keytool Restricted site name: Quiktalk.com
User name: girllovely Restricted site name: Quiksales.com
User name: girllovely Restricted site name: CostFree.org

a) Person sends an email to lovelygirl at the Global Address Directory which has no previous existing record of her; message is binned as unidentified and unattached. This creates the first sequence of the dynamic endless sequence address at Global Address Directory.com and this sequence now waits for a user initiation→

lovelygirlglobalmatchfreecom@GlobalAddressDirectory.com

b) At a later date, another person chooses from another site the user name, violet, and sends a message as well, this message also now waits for a user initiation→

violetworldwidematchfreecom@GlobalAddressDirectory.com

c) The endless sequence address and user name is formed when Jane Doe identifies herself on the Global Address Directory and looks to see if she has mail from various locations. She creates and initiates her endless sequence user name at the directory which would be composed of her various entered user names combined with the relevant site names including com or org or net etc., on the end of each sequence section as a sequence code with a separator character such as a period inserted between each sequence section, telephone numbers, address, etc., ending with a directory issued account number. The separating type character used below is a period and is only representative of any acceptable separating type character used to be an identifying separator of a sequence section:
Lovelygirlglobalmatchfreecom.violetworldwidematchfreecom.
keytoolquiktalkcom.girllovelyquiksalescom.girllovelycostfreeorg. 8049995555.6556 Grace StRichmondVA23230.99999xyz @GlobalAddressDirectory.com

d) Jane Doe would gain access to her alias messages as each section of the endless sequence code would identify her and give her proportional and/or total access to her corresponding sequence message and/or all messages. If she and/or any person and/or entity have intentionally harvested messages that are not theirs, they would be subject to sizeable, fully collectable internal fines which would be collectable as a debt against the certain value cost repayment due back to them as a consumer and/or organization member. This fine would be accrued whenever a violation was identified. This would be a monetary deterrent to keep messages safe.

e) The organization could option to pay compensation from these funds to the party if any whose privacy is violated. Jane Doe would add endless user names or identifiers to her endless access code as time progresses. This method, system and means provides a unique method of identifying users and or members as they progress through various stages of interaction with the organization and provides deterrent for spam and other online negative behavior.

The method and apparatus provides to create and secure completely collectable credit cards and debt instruments and provide cost free goods and cost free services to consumers and organization members as individuals or corporate or other entities or government entities worldwide and or to provide and or sell goods and or services to consumers and organization members and to return to and or credit to the account of the consumer and or organization member on or about a future date and or on a specific date, and or within a specific date range, and or on an unspecified date after a stated due date the entire amount or greater of all established certain value monies collected from the consumer or organization member for a goods and or services transaction provided to the consumer and or organization member by this invention and or through this program and to insure a means of purchasing a zero coupon note and or any other financial instrument and or investment that is designed, and or identified and organization qualified to fund the payment to the consumer and or organization member of a certain value future benefit and or certain value future liabilities in account composed of in specific part or in whole of a certain value future benefit and or certain value liabilities in an account and or grouping of accounts and thereby provide fully for the repayment and future cost of the certain value future benefit and or certain value liabilities in specific part or account entirety as a whole utilizing the time component of a flexible and or extendable as needed actual payout date.

The method, system and means provides for the acceptance and or receipt of a certain value amount from a consumer and or organization member for a delivered product and or service while expending and or paying a lesser amount for the product and or service. Subsequently then through the use by the organization of a lesser amount acquired by the organization from the proceeds of the exchange as the difference between the cost of product and or service to the organization and or in the case of a affiliate merchant transactions the affiliate referral commission income, either which would represent positive inflow of funds and from these funds and others the organization would purchase and hold till maturity and or determined date by the organization of a zero coupon note and or any other financial instrument that is designed and or identified and qualified and accepted by the organization to fund the partial payment and or payment and or repayment of a future benefit of certain value and or credit to a certain value benefit in an account composed of various certain value liabilities in part or in whole with the payoff amount of the zero coupon note, and or various multiple zero coupon notes, and or other financial instrument with a maturity certain value less than or equal to the certain amount of the future certain benefit and or certain liabilities in account and or grouping of accounts at a future date and or on a specific date, and or within a specific date range, and or on an unspecified date after a stated due date.

The system, method and means provides the process to project the predetermined payment with approximate deductions and or additions if any and repayment date and or dates of a certain future benefit and or combined certain future liabilities in an account composed of in specific part or in whole of a certain value future benefit and or certain value liabilities in an account and thereby calculates to provide for the payment and future cost of the certain value future benefit and or certain value liabilities in specific part or account entirety as a whole utilizing the component of a flexible and or extendable as needed actual payout date and then calculates the current cost of the zero coupon note, and or zero coupon notes, and or other financial instrument and provides for its safe keeping or depository as financial instrument or monies and final disbursement of monies and or application of funds and or monies and or credit to the certain value future benefit and or certain value liabilities in account and or grouping of accounts on the predetermined date or series of dates projected and utilizing the flexible and or extendable actual payout date as needed.

This invention provides the system and method for the organization to capitalize on the inherent consumer and or organization members self-interest motivated loyalty to support the organization providing cost free goods and services and create and operate various supplemental divisions providing high margin products and services for marketing to consumers and or organization members to supplement investment income for future fund funding and to provide in house loan departments and issue organization credit cards that will establish organization determined interest rates for issue to its members providing and or securing the organization with internally controlled financial instruments with internally controlled interest rate returns and provide the organization with the method for creating and or securing and collecting on 100 percent collectible full recourse in-house created debt instruments by retaining the right to collect organization owned debt with full recourse against any certain value cost repayment payable to an organization member as well as purchasing and securing external debt owed by organization members thereby converting and securing this external debt into fully collectible in-house debt instruments.

This invention provides the system and method for operating a cost free economics benefits program wherein a consumer and or organization member, the user, as incentive for the user to participate in cost free transactions with the organization and or affiliate merchants and or other entities for the purchase of goods or services and subsequently receives as a future benefit on or after a future date the total certain cost value of each cost free transaction, or greater, made by the user from the organization or from one or a plurality of independent product or service providing entities and or affiliate merchants associated with the organization, with each documenting the user's total cost free transactions and reporting the total transaction amount of each cost free transaction to an organization server where the users future benefits are tabulated to the users future fund account. The organization server accumulates all of the user's reported and tabulated cost free transactions and or marketing associate commissions earned as reported to and or by the organization and or by the product or service providing entities or affiliate merchants to the organization servers and tabulates the individual cost free transaction totals and or marketing associate commission totals into the user's future fund account associated with the user by the user's endless sequence dynamic identifier and access code. The system includes a means for identifying the user, a means for inputting the identification information and other information about the cost free transaction into a computer data storage, a computer data processing device which uses a software program along with the transactional information to calculate marketing associate commissions earned and a means for transferring monetary funds equal to the certain cost future benefit amount and marketing associate commission amounts from the Investment Funds Management Division to the users future fund account as released by the organization, and a means of reporting the amounts to the user and to the organization. Embodiments of a method of conducting a cost free economics benefits program incentive system of the present invention are also disclosed comprising the steps of inputting transactional information into a computer data storage device, calculating the total commission and benefit amounts through the use of a computer data processing device, transferring monetary funds equal to the benefit amounts when released by the organization from the Investment Funds Management Division to the users future fund account, and reporting the total cost free transaction and any marketing associate commissions earned the user and to the organization.

### BRIEF DESCRIPTION OF THE DRAWING

A complete understanding of the present invention may be obtained by reference to the accompanying drawing, when considered in conjunction with the subsequent, detailed description, in which:

The attached drawing is a flow chart view of the invention.

For purposes of clarity and brevity, like elements and components will bear the same designations and numbering throughout the drawing.

### DETAILED DESCRIPTION DRAWING OF THE PREFERRED EMBODIMENT

The sole drawing depicts, in block diagram form, a preferred embodiment of a consumer maximum self-interest future benefit patronage incentive system and of the present invention. In the preferred embodiment shown, the consumer maximum self-interest future benefit incentive system 10 having the characteristics of the present invention provides means for search and listing and global availability of cost free products and or services with access provided to all internet users 23 of providers of transactions that return as benefits the entire amount or greater to the consumer and or searches and listings of the products and or services and provides means of providing search and listing functions not limited to any specific methods. In the preferred embodiment shown, the consumer maximum self-interest future benefit incentive system 10 having the characteristics of the present invention provides a means of identification, the endless sequence dynamic identifier and access code component of the invention 14 which is used to identify the individual consumer and or organization members 13 who interacts directly or by internet connection 23 with the organization and participates in a transaction with the organizations internal and external divisions 34 and or merchant, affiliate merchant, entity or affiliate entity 40. The identification means 12 contains various forms of identification information 14 dynamically added to by the consumer and or organization member 13 and or organization software 24 or other means 14 which identifies the consumer and or organization member 13 and can be endless in sequence. The consumer maximum self-interest benefit incentive system 10 of this embodiment also collects and reports information about the transaction that includes the total amount of the consumer and or organization members' expenditure 16 and any marketing associate commission 42 earned. This information along with the identification information identifying the consumer and or organization member 14 and or related marketing associate information 42 together make up a body of information which is referred to herein as the cost free transaction information 16. This preferred embodiment also includes an external internet connection 23 and internal interconnected network computer and data storage memory device 20 as well as an interconnected input device 18 for inputting and tabulating the cost free transaction information 16 into the interconnected computer and data storage memory devices 20. Also included in this preferred embodiment is an interconnected computer data processing device 22 and an interconnected software program 24. The computer data 22 processing device is in communication with the computer data 20 storage memory devices and input from all sources of relevant data, affiliate merchants, commissions, marketing associate program and commission tabulation, all future fund tabulation, interest calculations, interest if any, calculations and all relevant data storage 20 in which the cost free transaction information 16 and organization data is stored. The software program 24 is utilized by the computer data processing device 22 along with the cost free transaction information 16 to tabulate the cost free transaction future benefit amount 25 which is to be distributed as a monetary benefit to the consumer and 13 or organization member on or after a future date. The total amount of the cost free transaction 25 when it is released to the consumer and or organization members 13 future fund account 30 at a future date, completing the cost free cycle 10 with the consumer and or organization member 13, can also include calculated investment interest 42, if any, at the discretion of the organization management 34. Further included as part of this preferred embodiment is an Investment Funds Management Division 26 of the organization having means for long term compounded interest income, investment income and other income streams from subsidiary operations to include various separate funds such as but not be limited to a Secured Certain Cost Investment Fund, Donation Fund and Secured Certain Cost Final Payout Fund, Internal Loan and or Credit Card Fund, Member Debt Purchase and Adjustment Fund and to manage income streams from various internal and external organization divisions 34 such as but not limited to CostFreeTickets.com, CostFreeTravel.com, CostFreeAuctions.com, etc., generating financial reserves from income and investment funds that fund the certain cost future benefit amounts accumulated and a means of transferring 28 a portion of monetary funds equal to or greater than the certain cost future benefit amount as released by the organization management 34, the total transaction benefit amount 25 from the Investment Funds Management Division 26 to the consumer and or organization members future fund account 30 and any calculated marketing associate commission 42 as released. This preferred embodiment also includes a means for tabulating direct cost free transactions 42 between the organization internal and or external divisions 34 such as but not limited to CostFreeTickets.com, CostFreeTravel.com, CostFreeAuctions.com, etc., and the consumer and or organization member 13 as well as a means of reporting affiliate merchant cost free transactions 40 to relevant organization management 34 and to receive confirmation of completed cost free transactions and receive 32 organization earned commission payments from the affiliate merchant for a completed transaction referral 40 from the merchant involved in the affiliate cost free transaction related to the cost free transaction future benefit amount 25 of a tabulated transaction. In this embodiment, the means of reporting 36 includes a report posting 38 to the consumer and or organization members future fund account 30 after a transaction confirmation report from the affiliate merchant 40 and or from a marketing division of the organization 34. Also included in this preferred embodiment is a payment and acceptance means 32 for providing online payment services with separate means to convert products and services purchased through and or utilizing the payment service to cost free transactions providing a double the entire benefit total return self-interest advantage to consumers of each payment service cost free transaction combination purchase and or debiting an account or receiving payments 32 from internal or external division subsidiaries and receiving affiliate referral commission income 34 of the organization or accounts of any amounts as needed by the organization and to include the certain cost future fund monetary benefit as released by the organization; the cost free transaction, future benefit certain cost amount 25 which transfers to the consumer and or organization members future fund account 30 from the Investment Funds Management Division 26 when released by the organization management 34 on or after its future date. This embodiment also includes a means for the organization to varyingly control the interest amount 42, if any, on future fund benefits. Such means comprising instructions included in the software program 24 and interest calculation and special information 42. In this embodiment, the interest calculation instruction 42 is provided by the organization management 34 and is input into the computer data storage memory device 20 by way of input device 18 by the organization and or its software. The instructions in the software program 24 respond to the interest calculation instructions to the computer data processing device 22 to adapt the final future fund benefit amount 30 according to the discretion of the organization management 34. Marketing associate commissions earned are transferred to the related marketing associate consumer organization member 13 future fund account 40 as due at the discretion of the organization management 34.

In the operation of this preferred embodiment of the present invention, a cross platform messaging and identification system utilizing endless sequence dynamic identifiers and access code identification means having consumer and or organization members identification information is used to identify the consumer and or organization members of the transaction. The identification information from the identification means along with information about the transaction are both part of the cost free transaction data which is inputted into a computer data storage memory device. A computer data processing device that is in communication with the computer data storage memory device utilizes this cost free transaction data along with a software program to tabulate the cost free transaction amount that is to be recorded to the consumer and or organization members future fund benefit account as a benefit to the consumer and or organization member for participating in the transaction with the organization and or affiliate merchant. The expectation of having monetary funds equal to this cost free transaction amount transferred into one's future fund benefit account provides incentive to the consumer and or organization members to conduct the transaction with the organization and or affiliated merchant. At any time prior to the release of the monetary future fund certain cost benefit, the organization may elect to issue monetary interest to increase the future fund certain cost benefit incentive amount. After the interest, if any, is calculated, monetary funds equal to the future fund certain cost benefit amount are in fact transferred from a fund within the Investment Funds Management Division to the consumer and or organization members future fund account. Debit and credit means are employed to debit an account from the Investment Funds Management Division and credit to the consumer and or organization members future fund benefit account a monetary amount equal to the organizations tabulated future fund certain cost total plus interest if any minus organization determined chargeback's and or accumulated consumer and or organization debt or fees owned to the organization by the consumer and or organization member. Reporting means are utilized to report the future fund certain cost amount when released.

In the following description of elements of this preferred embodiment of the present invention, it is to be remembered that the particular examples presented for an element are for illustrative purposes only and not to be understood as being exhaustive listings of possible embodiments of the element.

The identification means can be made through online log by the consumer to the organization identification system utilizing the endless sequence dynamic identifier process and access code and or with any tangible item capable of storing the consumer and or organization member identifier utilizing the endless sequence dynamic identifier and access code information and readily transportable by a consumer and or organization member. For example, the identification means may be a plastic card with information recorded in a magnetic strip or in some other machine readable form, for example a pay service identification card, credit card or a credit card-like device. In the most preferred embodiment, an organization member card and or credit card and or bank card is used as the identification means.

The identification means contains identification information as part of the endless sequence dynamic identifier process and access code information. The identification information is information describing the identity of the consumer and or organization member and various points of specific reference added to throughout the period of relationship with the organization and a consumer and or organization account code. The identification information may include other information such as information describing the identity of the consumer and or organization member future fund account. In the most preferred embodiment, the identification information contained on the identification means includes an identification code and or number which identifies the consumer and or organization members and is used by the system to identify consumer and or organization members address, future fund account, and the location of the future fund account.

The initiating sequence of the initial identification markers of the endless sequence dynamic identifiers and access code for an organization non member is the organization registration information provided by the consumer non member at registration. Non registered consumers are initiated by any point of reference identified by the organizations computer during the initial consumer transaction of a non organization member such as basic information gathered from the visit and transaction purchase data identifying name, address etc. Additional identification references can be and are added to the initial sequence by the consumer and or organization and or the organization computer as needed and or as new identification markers are identified. Consumer and or organization member user can choose additional specific points of reference as well as the organization or the organization computer endless sequence dynamic identifier and access code software. New technology methods of reference can also be added as developed such as voice, facial and DNA sequence marker identification references.

The cost free transaction includes the identification information and information about the transaction between the consumer and or organization member and the organization, affiliate merchant, affiliate individual, entity, merchant or individual. The information about the transaction may include information such as the dollar value of the transaction, the date of the transaction, the location of the transaction, and the identity of the merchant. Information about the type or quantity of product or service involved in the transaction may also be included. In short, any information which the merchant may consider to be important may be included as the information about the transaction and thereby be made part of the cost free transaction.

The computer data storage memory device which is included in the preferred embodiment for storing the cost free transaction may be of any type which is compatible for use with the particular computer data processing means used in practicing the embodiment. Such computer data storage memory device is well known to those who are skilled in the art of computer hardware and data storage and retrieval and includes, but is not limited to, magnetic storage media such as floppy disks, hard drives, and tape drives as well as CD-ROM devices and RAM and ROM memory devices that are part of or used in conjunction with electronic computers such as personal computers, work station computers, and main frame computers. The computer data storage memory device may also be comprised of a plurality of components wherein each component stores a portion of the cost free transaction and each component is itself a type of computer data storage memory device such as was just described.

An input device for inputting the cost free transaction into a computer storage memory device is also included in the preferred embodiment. The input device may be an electronic card reader such as a credit card reader, a scanner, a computer keyboard or any other means known to one skilled in the art of inputting information into computer data storage memory devices. The input device may also consist of a plurality of components wherein each component is used to input a portion of the cost free transaction and each component is itself a type of input device such as was just described. In a most preferred embodiment wherein the identification means is a online login of the member user code enabling the endless sequence dynamic identifiers and access code and or at participating brick and mortar merchant location a member user card and or a credit card and or a bank card., the input device would include a component which is a card reader located at the sight of the transaction which would input the identification information contained on the credit card into a computer data storage memory device. This method, system and means provides a unique method of identifying users and or members as they progress through various stages of interaction with the organization and provides deterrent for spam and other online or off-line restricted financial behavior.

The software program may be any software program that is compatible with the computer data processing device so long as the software program is capable of causing the computer data processing device to tabulate the cost free transaction total amount for the cost free transaction. Such a software program is well within the knowledge of one skilled in the art of computer programming. In the most preferred embodiment, the software program also includes instructions which, when executed by the computer data processing device, cause a portion of the monetary funds of the investment management fund equal to the organization determined and released future benefit certain cost amount representative of the cost free transaction to be transferred by an electronic fund transfer system to consumer and or organization members future fund account. Also in the most preferred embodiment, the software program further includes instructions which after acceptance by the organization of a cost free transaction and when tabulated and executed by the computer data processing device, cause tabulation reports to be issued to the consumer and or organization members future fund account tabulating the total eligible cost free transaction amount to the consumer and or organizations future fund account and to the organization recording the amount of the cost free transaction total future benefit certain cost amount to be transferred to the consumer and or organization members future fund account on or after a future date minus any organization determined deductions.

The computer data processing device which utilizes the software program may be any type of electronic computer known to one skilled in the art of computers such as a personal computer or a work station computer or a main frame computer. The computer data processing device is in communication with the computer data storage memory device wherein the cost free transaction is stored so that the computer data processing device can and does utilize the cost free transaction and the software program to calculate and tabulate the future certain cost benefit amount that is to be transferred to the consumer and or organization members future fund account on or after a future date as determined by the organization utilizing the Extendable Time Component.

In the most preferred embodiment the computer data processing device is also in communication with or is part of an electronic funds transfer system also included in this preferred embodiment as a payment and acceptance means for providing online payment services with separate means to convert products and services purchased through and or utilizing the payment service to cost free transactions providing a double the entire benefit total return self-interest advantage option to consumers of each payment service cost free transaction combination purchase. The software program comprising means and includes instructions which operate the payment services functions and both internal and external transfers and, when executed by the computer data processing device, cause a portion of the monetary funds of the Investment Funds Management Division equal to the future certain cost benefit amount to be transferred by the electronic funds transfer system to the consumer and or organization members future fund account. Also in the most preferred embodiment, the online computer data processing device is in communication with an output device such as a modem or a printer and the software program includes instructions which, when executed by the computer data processing device, causes reports to be issued to the consumer and or organization member and to the organization telling of the amount of the cost free certain cost benefit amount transferred to the consumer and or organization members future fund account along with the portions of the cost free transaction and other information desired by the organization to be included in the report. Further, in the most preferred embodiment, the computer data processing device is in communication with an electronic funds transfer system and the software program also contains instructions which, when initiated by a eligible cost free transaction and or referred affiliate transaction at an affiliate merchant and executed by the computer data processing device, cause an account of the affiliate merchant, who was a party to the organization referred merchant transaction, to issue and or tabulate for future issue by electronic means or check an amount equal to the established affiliate merchant fee amount due the organization per the affiliate merchant agreement for the affiliated merchant sale to the referred consumer and or organization member.

The Investment Funds Management Division is the organization investment division with investment means that contains various investment funds utilizing but not to be limited to a combination of the following funding methods such as long term compounded interest, investment funding, credit card and loan operations and income streams from high margin digital economy products and services from subsidiary operations subsidiary companies from which the future certain cost benefit amount may be paid to the consumer and or organization members future fund account. The Investment Funds Management Division funds may contain and or be any type of an account known to one skilled in the art of banking or investing. The Investment Funds Management Division may also contain the Donation Fund for use by the organization with a future fixed or extendable or no return date of the donations or other reserve of monetary funds kept by the organization for the purpose of paying out the future certain cost benefit amounts to a consumer and or organization members future fund account on or after a future date as determined by the organization. The Investment Funds Management Division may also be comprised of a plurality of accounts or reserves or stores of monetary funds. In the most preferred embodiment, the Investment Funds Management Division is a grouping of organization investment funds with a bank account which is accessible by an electronic funds transfer system so that monetary funds may be transferred directly from the Investment Funds Management Division to a consumer and or organization members future fund account and monetary funds may be transferred into the Investment Funds Management Division from a affiliate merchant's account and or donors and or other entities.

The means for transferring a portion of the monetary funds equal to the future certain cost benefit amount from the Investment Funds Management Division to the consumer and or organization members future fund account may be any means for transferring monetary funds between a first monetary account, a monetary store, or a monetary reserve and a second monetary account known to one skilled in the art of monetary transfers. Any of the means of transferring monetary funds used in commerce, banking, or investment are within the contemplation of the preferred embodiment of the present invention. For example, in the most preferred embodiment, the means for transferring is an electronic funds transfer system. The means for transferring may also consist of a physical transference of monetary funds from the Investment Funds Management Division into the consumer and or organization members future fund account.

The means for reporting the future certain cost benefit amount to the consumer and or organization members and to the merchant may be any type of reporting means in use in commerce, banking, or investment and known to one skilled in any of these arts. For example, the means for reporting may be paper reports, stating the future benefit certain cost amount, mailed to the consumer and or organization members and to the merchant. The means for reporting may include a telephonic communication of the future benefit certain cost amount to the consumer and or organization member and or others. The means for reporting may be an electronic communication stating the future benefit certain cost amount sent to the consumer and or organization member and or others over such means as the Internet. The means for reporting may consist of a plurality of components wherein each component is itself a means of reporting such as was just described and one component is employed to communicate the future benefit certain cost amount to the consumer and or organization member and another component is used to communicate the future certain cost account amount to the others. In the most preferred embodiment, the means of reporting the future certain cost account to the consumer and or organization member and or others is a online report, issued monthly, of the account statement type commonly employed by banks to report account activity online to the account holders. In the most preferred embodiment, the means of reporting also includes portions of the cost free transaction and other information desired by the organization to be included in the report. Also, in the most preferred embodiment, the means of reporting also could include a final report send to the consumer and or organization members future fund account which states a summary of all the future benefit certain cost amounts which were tabulated over time from participating in the cost free consumer maximum self-interest benefit system.

The future fund account of the consumer and or organization member may be any form of an internal organization account and or at a bank, brokerage house or an investment company which the organization utilizes for future fund activity and designates as being the account into which future certain cost accounts are to be transferred. Each consumer and or organization member that participates in the consumer maximum self-interest benefit incentive system has his own future fund account issued to him by the organization.

A consumer maximum self-interest benefit incentive system of the present invention may be adapted for the participation of the organization and one or more merchants and or one or more affiliate merchants and or one or more other participating entities and one or more consumer and or organization members. The present invention contemplates embodiments of the preferred consumer maximum self-interest benefit incentive system to be employed the organization independently and or by as few as one participating affiliate merchant for the purpose of providing one or more consumer and or organization members with incentive to conduct transactions with the merchant as well as embodiments wherein a plurality of merchants employ the consumer maximum self-interest benefit incentive system to provide incentive to one or more consumer and or organization members to conduct transactions with one or more of those merchants.

Where multiple merchants and or affiliate merchants participate in the consumer maximum self-interest benefit incentive system of the present invention, the most preferred embodiment of a consumer maximum self-interest benefit incentive system includes a means for transferring from an account of the affiliate merchant involved in the transaction for at least an amount equal to the affiliate merchant fee or commission due the organization which is be transferred to the organization for that referred transaction. A means for transferring the affiliate merchant fee or commission due the organization is also most preferably included in embodiments of the present invention which are adapted for the use of a single merchant.

At least part of the funds received from the affiliate merchant as affiliate commission or fee of a product or service sale to a consumer and or organization member under this invention is transferred directly or indirectly into the Investment Funds Management Division for investment funding of the future certain cost benefit amount being the funding of the future benefit of certain cost for a future date utilizing the extendable time component to adjust the future payout date through the needed funding period.

Also within the contemplation of a preferred embodiment of the present invention is the inclusion within the consumer maximum self-interest benefit incentive system of a means for the organization to varyingly increase the amount of the future benefit amount with the combination of transactions by utilizing the organization payment services with separate means to convert products and services purchased through and or utilizing the payment service to cost free transactions providing a double the entire benefit total return self-interest advantage to consumers of each payment service cost free transaction combination purchase as well as the added benefit of interest addition at the organizations discretion. Though all embodiments of the present invention include the tabulation of the total transaction future benefit certain cost amount, the further inclusion of a means for doubling the actual amount of a cost free transaction benefit and varyingly adding interest and controlling the future benefit amount with interest, if any, provides the consumer and the organization greater control to tailor the amount of the future benefit according to the amount of incentive needed to provide the consumer and or organization member with overwhelming incentive to maintain loyalty to this system as the maximum consumer self-interest benefit program and system. It is an embodiment of the invention to provide economic transactions or other transactions that return as a benefit the entire amount of the transaction or greater to any entity or individual or purchaser or seller and or other party and to include or not include a commission to purchaser, seller or other party and inclusion of means to provide, secure and fund said transactions.

In the most preferred embodiment, the means for control are instructions in the software program which respond at the direction of the organization to future fund account certain cost special information provided by the organization to the computer data processing device during the execution of the software program while the future benefit certain cost amount is tabulated. The future benefit certain cost amount special information may include information at the organizations discretion that causes the future certain cost account amount to be increased by a certain percentage.

Also within the contemplation of a preferred embodiment of the present invention is the inclusion of means for operating a marketing associate program where each registered organization member earns and is paid to their future fund account and or by check or electronic transfer a marketing associate commission income earned from the transactions made by members sponsored, as determined by the organization and or any other means. This said commission being a commission earned and tabulated from all cost free transactions and or other commissionable transactions made with the organization and or affiliate merchants and or other entities by any organization member that was sponsored and registered as a new organization member by the said marketing associate member and designated sponsor.

The future certain cost account amount special information may also include information that causes the future benefit certain cost amount to be related to threshold levels of the monetary value of the goods or services that are involved in the transaction and or the organization pay services used. The future benefit certain cost amount special information may include information that causes the future benefit certain cost amount to be related to threshold levels of the number or frequency of transactions which the consumer and or organization member has transacted with the organization and or affiliate merchant. Though information similar to the future benefit certain cost amount special information may be also employed by an embodiment which does not include a means for varyingly controlling the future benefit certain cost amount, the inclusion of such a means for varyingly controlling the future benefit certain cost amount by providing an interest option and or the consumer option to utilize the organization pay services to increase benefits of each transaction allows the consumer and or organization to adjust the amount of incentive that is to be returned as a future benefit for each cost free transaction.

In embodiments of the present invention which are adapted to the participation of a plurality of merchants and or affiliate merchants and or other entities, the most preferred of these embodiments include the use of a means for varyingly controlling the future benefit certain cost amount where the means for controlling comprise a consumer option to utilize the organizations pay services option purchase process to combine additional transaction benefit and multiply the total future benefit amount and instructions in the software program which respond to future benefit certain cost special information provided by the organization to the computer data processing device during the execution of the software program while the future benefit certain cost amount is being tabulated.

The present invention also includes a method for conducting a consumer maximum self-interest benefit incentive system comprising the step of inputting into computer data storage memory device information about a transaction between a consumer and or organization member and the organization and or a affiliate merchant or merchants and or other entities participating in the consumer maximum self-interest benefit incentive system. The information to be input includes the cost free transaction. The method also comprises the step of calculating and funding a future benefit certain cost amount for the transaction by using a computer data processing device of a type described above. The method further comprises a step of transferring monetary funds equal to the future benefit certain cost amount of the cost free transaction from an Investment Funds Management Division to the consumer and or organization members' future fund account. The method also comprises a step of reporting the future benefit certain cost amount to the consumer and or organization members future fund account. The method also comprises the steps of tabulating and issuing a transaction commission to the sponsor marketing associate.

A preferred embodiment of the method for conducting a consumer maximum self-interest benefit system includes the employment of the elements already described herein for embodiments of the consumer maximum self-interest benefit system of the present invention. In this embodiment of the method of the present invention, the step of inputting into computer data memory device information about a transaction between a consumer and or organization member and the organization and or an affiliate merchant comprises the merchant inputting the cost free transaction using the input means described previously. Alternatively, the consumer and or organization member may input a portion of the cost free transaction, for example the identification information, and the merchant input the balance of the cost free transaction. The cost free transaction is input into a computer data storage memory device such as was herein previously described. In the most preferred embodiment, consumer and or organization member online login code as described above and or pay services member card and or a credit card is used as the identification means and the identification information portion of the cost free transaction is input by either the merchant or the consumer and or organization member using a credit card reader and or online log in to input the identification information.

In the preferred embodiment, the step of calculating the future benefit certain cost amount by using a computer data processing device is carried out by utilizing a software program and a computer data processing device in communication with the computer data memory device which stores the cost free transaction where each of these items is as was herein previously described. Also in this embodiment, the step of transferring monetary funds equal to the future benefit certain cost amount from the Investment Funds Management Division to the consumer and or organization members future fund account comprises the use of the Investment Funds Management Division, a consumer and or organization member future fund account, and a means for transferring a portion of the monetary funds of the Investment Funds Management Division from the Investment Funds Management Division to the consumer and or organization members future fund account where each of these items is as was herein previously described. In the most preferred embodiment, the Investment Funds Management Division is the investment division of the organization providing for the funding of the future benefit, the cost free expenditure, of future certain cost to be returned on or after a future date utilizing the extendable time component to adjust the future payout date through the needed funding period and creating and securing, internally secured, totally collectible debt and operating a donation fund for use by the organization with a future fixed or extendable or no return date of the donations for the auxiliary funding of the future benefit of certain cost for a future date and is provided with a bank account which is accessible by an electronic funds transfer system and the monetary benefit funds are transferred directly from the Investment Funds Management Division to the consumer and or organization members future fund account when released by the organization.

In the preferred embodiment, the step of reporting the future benefit certain cost amount to the consumer and or organization member and to the merchant is accomplished by using the means of reporting as was herein previously described. For example, the step of reporting the future benefit certain cost amount may be accomplished by online reporting and or e mailing to the consumer and or organization member stating the future benefit certain cost amount. In the most preferred embodiment, the step of reporting is accomplished by reporting online to the consumer and or organization members and tabulating to the future fund account on a monthly basis, reports of the account statement type commonly employed by online banks to report account activity. In the most preferred embodiment, the means of reporting also includes portions of the cost free transaction and other information, such as promotional advertising, desired by the organization to be included with or in the report. Also, in the most preferred embodiment, the online report emailed and or online posted to the consumer and or organization members future fund account could include a summary report stating for the consumer and or organization member a summary of all the future benefit certain cost amounts which are accumulated and or he has received over time from participating in the cost free future benefit system.

Embodiments of the method of the present invention may include participation by the organization and or one or more merchants and or one or more affiliate merchants and or one or more other entities and by one or more consumer and or organization members. In the most preferred embodiment, the method includes the participation of the organization and or by a plurality of various affiliate merchants and or a plurality of merchants and or a plurality of other entities and or a plurality of consumer and or organization members.

A preferred embodiment of the method of the present invention also comprises the step of accepting payment from or debiting an account of an affiliate merchant for an amount which is at least equal to the affiliate referral commission and or fee earned by the organization for the consumer transaction referral between the organization and the participating affiliate merchant and or merchant and or participating other entity for the consumer transaction. This commission payment is deposited by check or electronic debit to the Investment Funds Management Division with at least a minimum percentage of the total amount remaining in the Investment Funds Management Division for investment funding of the future certain cost. The step of receiving payment from or debiting an account of the merchant may be accomplished by any method of check or physical deposit, account debiting and or deposit known to one skilled in the arts of banking or investing. In the most preferred embodiment, the debiting step is accomplished by including in a software program instructions which, when executed by the computer data processing device which also calculates the future certain cost transaction amount and affiliate commission owed to the organization, cause an account of the merchant and or entity, who was a party to the transaction, to issue a check payment and or be debited by an electronic funds transfer system for an amount equal to at least the affiliate commission or fee earned by the organization and transferred to the Investment Funds Management Division.

A preferred embodiment of the method of the present invention comprises further the step of the organization varyingly controlling the future benefit certain cost amount with additional interest, if any. This step is accomplished by the use of any of the means for the organization to varyingly control the amount of the future certain cost account amount as was herein previously described. Though all embodiments of the method of the present invention include a step of calculating and tabulating a future certain cost amount, the further inclusion of a step of the organization controlling the future benefit certain cost amount gives the merchant greater control to adjust the future benefit certain cost amount according to the amount of incentive the organization wants to provide to the consumer and or organization member in combination of the total of future fund benefits and or simply providing for additional incentive as interest earning incentive on specific cost free transactions or types of transaction.

In the most preferred embodiment, the step of the organization varyingly controlling the future benefit certain cost amount is accomplished by employing instructions in the software program which respond to future benefit certain cost amount special information provided by the organization to the computer data processing device after the execution of the software program after the future benefit certain cost amount has been tabulated. The future benefit certain cost amount special information may include information that causes the future benefit certain cost amount to be increase by a certain percentage as determined by the organization. The future benefit certain cost amount special information may include information that may cause the future benefit certain cost amount to be related to the organizations pay services method used by the consumer and or threshold levels of the monetary value of the goods or services purchased. The future benefit certain cost amount special information may include information that causes at the discretion of the organization, the future benefit certain cost amount to be related to threshold levels of the number or frequency of transactions which the consumer and or organization members has transacted with the organization and or through the organizations pay services.

Though information similar to the future benefit certain cost amount special information may be also employed by an embodiment which does not include a step of the organization and or consumer to varyingly controlling the future certain cost amount, the inclusion of a step for varyingly controlling the future benefit certain cost amount allows the organization and or the consumer to adjust the future benefit certain cost amount benefit that is to be provided for each transaction to which the organization is a party based on the amount of incentive the organization wants to provide to the consumer and or organization member and the incentive chosen by the consumer to participate in the future benefit system transaction.

The most preferred embodiment of the method of the present invention includes the step of using an online member code login and or a pay services membership card and or credit card to identify the consumer and or organization members who participates in the transaction. In other words, in this embodiment, in this step, a variety of card is used by the consumer and or organization members as the identification means as was herein previously described.

The present invention, both the consumer maximum self-interest benefit incentive system and the method thereof, may be used by the organization and each participating merchant, affiliate merchant and or other participating entity to provide incentive to one or more consumer and or organization members to enter into transactions for cost free goods or services. The present invention provides the advantage over the prior art, most utilize the return of only partial amounts of a transaction as an incentive fulfilling a portion of a consumers self-interest desire and need to provide for savings as an incentive for the consumer to enter into a transaction.

Embodiments are disclosed of a system and method for operating a cost free economics benefits program wherein a consumer and or organization member, the user, as incentive for the user and or a plurality of users to participate in cost free transactions with the organization and or affiliate merchants and or other entities for the purchase of goods or services receives as a future benefit on or after a future date the total certain cost value of each cost free transaction made by the user from the organization or from one or a plurality of independent product or service providing entities and or affiliate merchants associated with the organization, with each documenting the user's total cost free transactions and reporting the total transaction amount of each cost free transaction to a organization server where the users future benefits are tabulated to the users future fund account. The organization server accumulates all of the users reported and tabulated cost free transactions and or marketing associate commissions earned as reported to and or by the organization and or by the product or service providing entities or affiliate merchants to the organization servers and tabulate the individual cost free transaction totals and or marketing associate commission totals into the users future fund account associated with the user by the users endless sequence dynamic identifiers and access code. The system includes a means for identifying the user, a means for inputting the identification information and other information about the cost free transaction into a computer data storage, a computer data processing device which uses a software program along with the transactional information to calculate marketing associate commissions earned and a means for transferring monetary funds equal to the certain cost future benefit amount and marketing associate commission amounts from the Investment Funds Management Division to the users future fund account as released by the organization, and a means of reporting the amounts to the user and to the organization. Embodiments of a method of conducting a cost free economics benefits program incentive system of the present invention are also disclosed comprising the steps of inputting transactional information into a computer data storage device, calculating the total commission and benefit amounts through the use of a computer data processing device, transferring monetary funds equal to the benefit amounts when released by the organization from the Investment Funds Management Division to the users future fund account, and reporting the total cost free transaction and any marketing associate commissions earned to the user and to the organization.

The present invention provides advantage over prior art and is novel in providing maximum self-interest incentive benefits in the form of future monetary benefits made directly to the consumer and or organization members future fund account of the total cost free transaction expenditures made by the participating consumer and or organization member providing a save all you spend maximum consumer incentive to participate in the benefit system. The present invention provides the advantage over the prior art, and provides the system to maintain maximum consumer loyalty with the added interest incentives at the discretion of the organization for a save all you spend and more additional incentive to participate in the benefit system.

In addition to providing these advantages, the present invention overcomes several of the drawbacks present in prior art consumer future benefit incentive systems described herein.

While preferred embodiments of the present invention are described herein, it is to be distinctly understood that the present invention is not limited thereto but may be otherwise embodied and practiced within the scope of the following claims. Since other modifications and changes varied to fit particular operating requirements and environments will be apparent to those skilled in the art, the invention is not considered limited to the examples chosen for purposes of disclosure, and covers all changes and modifications which do not constitute departures from the true spirit and scope of this invention.

Having thus described the invention, the claims appended hereto are meant to encompass all alternatives and modifications within the scope and spirit of the present invention.

What is claimed is:

1. A patronage incentive future benefits system for promoting a consumer to enter into a transaction with a provider of goods or services, said patronage incentive future benefits system comprising:
(a) a future benefit amount comprised of a related amount equal to the entire amount of said transaction or a greater amount;
(b) a said future benefit amount total tabulated, then from a lesser amount invested, funded and realeased by said organization, returned at a future date as a benefit to the consumer and or organization member at a greater amount equal to future benefit amount total or greater, the said transaction;
(c) a provider of goods and services and cost free goods and cost free services; provider being the organization and or its affiliate merchants and or other entities;
(d) a means to fund the said future benefit comprised from a initial smaller amount and returned as a benefit as an amount equal to the entire amount of the said transaction or greater;
(e) an identification means for identifying a consumer participating in transactions with the provider of the patronage incentive future benefits system, said transactions involving said goods or services of said providing organization and or affiliate merchants and or other entities, said identification means having identification information about said consumer and or organization member;
(f) a cross platform messaging and identification system utilizing endless sequence dynamic identification identifiers and access code identification means for identifying a consumer and or organization member who participates in a cost free transaction with the organization and or its affiliate merchants and or other entities, said transaction involving goods or services of said organization and or its affiliate merchants and or other entities, said identification means having identification information about said consumer and or organization member, and said consumer and or organization member having a future benefit fund account with the organization;
(g) transactional information including said identification information;
(h) a computer data storage memory device for storing said transactional information and an input device for inputting said transactional information into said storage memory device;
(i) a software program for tabulating and recording the total transaction amount as an incentive future benefit amount, the future certain cost benefit;
(j) a computer data processing device for utilizing said software program, said computer data processing device being in communication with said computer data storage memory device and having online access;
(k) an investment funds management division having investment means and funds providing for the funding of the future certain cost benefit of larger amount from a smaller amount for a future date on or after a future date utilizing an extendable time component to adjust the future payout date of the future certain cost benefit amount through the needed funding period;
(l) a means for tabulating and recording said incentive future benefit amount of the total of a transaction to said organization and consumer's future fund account;
(m) a means for transferring a portion of said investment funds totaling said transaction amount from said investment funds management division to said consumer and or organization member's future fund account;
(n) an identification means for identifying said consumer participating in said transaction with said provider of the incentive future benefits system, said transaction involving goods or services of said provider and or said provider's affiliate merchants and or other entities, said identification means having identification information about said consumer;
(o) a means for operating a marketing associate program by which registered organization members earn and are paid to their future fund account or by check or electronic transfer a marketing associate commission income, as determined by the organization and or any other means, from all said transactions and or other commissionable transactions completed with the organization and or affiliate merchants and or other entities by any organization member sponsored and registered as a new organization member by a marketing associate member sponsor;
(p) a means for providing multi-generational levels of benefits by providing cost free goods and services to consumers and or organization members and engaging them in a mandatory, contained program that results in savings and future financial benefit to them and their primary levels of heirs, primary levels of heirs as being assigns, spouse, children and grandchildren, on a future date or unspecified future dates, said benefits being composed of the total amount or greater of said transaction expenditures made by the consumer and or organization member;
(q) a means to provide economic transactions or other transactions that return as a benefit the entire amount of the transaction or greater to any entity or individual or purchaser or seller and or other party and to include or not include a commission to purchaser, seller or other party; said transactions being cost free transactions
(r) a means to promote and maintain maximum consumer self-interest loyalty and patronage and maximum consumer benefit by providing cost free goods and services combined with ever growing asset of future fund benefits.
(s) a means to provide payment services online and off-line comprising monetary exchange and credit card functions with means to convert any purchase to a future benefit saved.
(t) a means to tabulate and pay marketing associate commissions on transactions with the organization and its affiliate merchants and other entities.

2. A patronage incentive future benefits system as described in claim 1, wherein said future fund account comprises a future fund account maintained at and by the organization on behalf of a consumer and or organization member.

3. A patronage incentive future benefits system as described in claim 1, wherein said identification means comprises the consumer and or organization member's endless sequence dynamic identifiers and access code.

4. A patronage incentive future benefits system as described in claim 1, wherein said identification means comprises the consumer and or organization member's endless sequence dynamic identification identifiers and access code or a credit card, and or a payment services member card.

5. A patronage incentive future benefits system as described in claim 1, wherein said means for transferring a portion of said investment funds from said investment funds management division to said future fund account of said consumer and or organization member comprises an electronic transfer means for transferring a portion of said monetary funds from said investment funds management division to said future fund account of said consumer and or organization member.

6. A patronage incentive future benefits system as described in claim 1, wherein said incentive future benefits system accommodates participation of one or more of a plurality of entities composed of the organization and or affiliate merchants and or individuals and or other entities and or a consumer and or organization member.

7. A patronage incentive future benefits system as described in claim 1, wherein said incentive future benefits system accommodates participation of a plurality of consumer and or organization member users.

8. A patronage incentive future benefits system as described in claim 6, wherein said incentive future benefits system accommodates participation of a plurality of consumer and or organization members.

9. A patronage incentive future benefits system as described in claim 1, further comprising a means for varyingly controlling said incentive future benefit amount with additional interest benefit, if any, computed and added to the consumer and or organization member's future fund account at the discretion of said organization.

10. A patronage incentive future benefits system as described in claim 1, wherein said cost free transactional information further comprises, when totaled, the tabulated future certain cost benefit amount total and special information.

11. A method of operating a member marketing associate commission income system and incentive future benefits system for motivating a consumer and or organization member to enter into a cost free transaction with the organization and or its affiliate merchants and or other entities for goods or services, and for maintaining the maximum self-interest loyalty of the consumer and or organization member's repeat customer loyalty motivations, said method comprising the steps of:
(a) inputting into a computer data memory device information about a cost free transaction between the consumer and or organization member and said organization, the provider of the incentive future benefits system, said transaction involving goods or services of the organization and or affiliate merchants and or other entities;
(b) tabulating and recording the cost free transaction amount as the future certain cost incentive benefit amount and tabulating the incentive future benefit amount and or related marketing associate commission to the consumer and or organization member's future fund account by using a computer data processing device;
(c) transferring funds from the investment funds management division having means, investments and monetary funds, after the release of said incentive future benefit amount by the organization to the future fund account of said consumer and or organization member, a portion of said monetary funds equal to the said future certain cost incentive benefit amount, plus organization computed and applied interest if any, minus any organization deducted fees and or charges of the organization at the discretion of the organization, completing the cost free transaction and;
(d) tabulating and recording said future certain cost incentive benefit amounts and interest and or deductions if any and or related marketing associate commission income to said consumer and or organization members future fund account and to said organization;
(e) operating a marketing associate program whereby a registered organization member earns a marketing associate commission income from any cost free or other commissionable transaction made with the organization and or with affiliate merchants and or other entities by any organization member that was recruited and registered as a new organization member by that marketing associate member;
(f) operating a system and method of economic transaction or other transactions whereby the consumer benefits the return of the entire amount of the said transaction or greater as a future benefit self-interest patronage incentive.

12. The method of operating a patronage incentive future benefits system described in claim 11, wherein the step of transferring from the investment funds management division having investments and monetary funds to a future fund account of said consumer and or organization member comprises electronically transferring of said monetary funds on or after a release date by the organization.

13. The method of operating a patronage incentive future benefits system described in claim 11, further comprising the step of receiving payments by check or other means or debiting an account of an affiliate merchant and or other affiliate entity for an amount equal to at least the affiliate referral commission earned by the organization and owed to the organization by the merchant at the end of an affiliate referred cost free transaction for referring the consumer and or organization member transaction and internally providing marketing associate commissions.

14. The method of operating a patronage incentive future benefits system described in claim 11, further comprising the step of varyingly increasing said incentive future benefit amount totals with an addition of calculated interest.

15. The method of operating a patronage incentive future benefits system described in claim 11, further comprising the step of using a credit card and or pay services card or account independently and or credit card or pay services member card information as a reference point in the endless sequence dynamic identifier and access code to identify said consumer and or organization member.

16. The method of operating a patronage incentive future benefits system described in claim 11, further comprising the step of providing multi-generational levels of benefits comprised of said entire transaction amounts or greater.

17. The method of operating a patronage incentive future benefits system described in claim 11, further comprising the step of providing the system for one or a plurality of entities to online or off-line list and or search for a fee and or promote for a fee and or online or off-line to search and or list for free and or promote for free to sell any cost free product or service and or for the consumer and or organization member to search and purchase from non-organization sites or entities and to subsequently convert any resulting transaction to a cost free transaction providing for the return to the consumer of the total transaction amount or a greater-amount as a future benefit amount.

18. The system and method of economic transaction of purchasing a product or service that returns as a benefit an amount equal to the entire amount of a transaction or greater to any entity or individual or purchaser or seller and or other party and to include or not include a commission to purchaser, seller or other party.

19. The system and method for promoting as an incentive an economic transaction or other transactions that return as a benefit an amount equal to the entire cost amount of a product or service or greater, to any entity or individual or purchaser or seller and or other party and includes or does not include a commission to purchaser, seller or other party.
